(19) United States
(12) Patent Application Publication
(10) Pub. No.: US 2003/0128700 A1
(43) Pub. Date: Jul. 10, 2003

(54) Method and system for providing a filter for a router

(75) Inventor: Andrew J. Bernoth, Longmont, CO (US)

Correspondence Address: Steven Fischman, Esq., Scully, Scott, Murphy & Presser, 400 Garden City Plaza, Garden City, NY, 11530, US

(73) Assignee: INTERNATIONAL BUSINESS MACHINES CORPORATION, ARMONK, NY

(21) Appl. No.: 10/042,967

(22) Filed: Jan. 9, 2002

(51) Int. Cl. H04L 12/28

(52) U.S. Cl. 370/389; 370/395.21

(57) ABSTRACT

A method and system for providing a standardized set of filters for a router. A set of pre-written filters are provided in a file, and a program is run on a computer to identify one of these pre-written filters as a substitute for a filter that was specifically written for the router. The standardized filter file is then loaded onto the router and the identified substitute filters are used instead of the filter that has been specifically written for the router. Preferably, the computer program is used to identify which one of the prewritten filters of the pre-written filter files most closely matches, according to a predefined test, the filter file written specifically for the router.

### BACKGROUND OF THE INVENTION

1. Field of the Invention

This invention generally relates to routers, and more specifically, to procedures for providing routers with filters.

2. Prior Art

Routers are used to direct data among and between subnetworks or devices of a network. Since a network can include tens of thousands of individually addressable devices, the operation of a router can be quite complex.

In order to perform their complex operations, routers may be provided with filters, which are sets of rules that determine how the routers transmit data. For instance, when a router receives data, a filter may be used to determine the type or class of the data, or a filter may be employed to determine when, where and how to send the data.

Occasionally, after a network has been designed and implemented and is in use, a filter may be written specifically for the network in order to address circumstances or situations comparatively specific to that network. Although the people writing such specific filters may be very knowledgeable about certain aspects of the operation and needs of the network, these people often have very limited expertise or experience in writing filters. Because of this, these specifically written filters may not be very effective, or may actually have adverse unintended consequences.

### SUMMARY OF THE INVENTION

An object of this invention is to improve procedures for providing filters for routers.

Another object of the present invention is to provide a router with a better, substitute filter for a filter specifically written for the router.

These and other objectives are attained with a method and system for providing a filter file for a router. A set of pre-written standardized filters are provided, and a program is run on a computer to identify one of these pre-written filters as a substitute for a nonstandard filter that was written specifically for the router. That identified substitute filter is loaded onto the router and used instead of the filter that had been specifically written for the router. Preferably, the computer program is used to identify which one of the pre-written standardized filters most closely matches, according to a predefined test, the filter written specifically for the router.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 shows a network having a router and a group of subnetworks.

FIG. 2 is a flow chart illustrating a preferred implementation of this invention.

FIG. 3 show a computer system that may be used in the practice of the invention.

FIG. 4 illustrates a memory medium that can be used to hold a computer program for carrying out this invention.

### DETAILED DESCRIPTION OF THE PREFERRED EMBODIMENTS

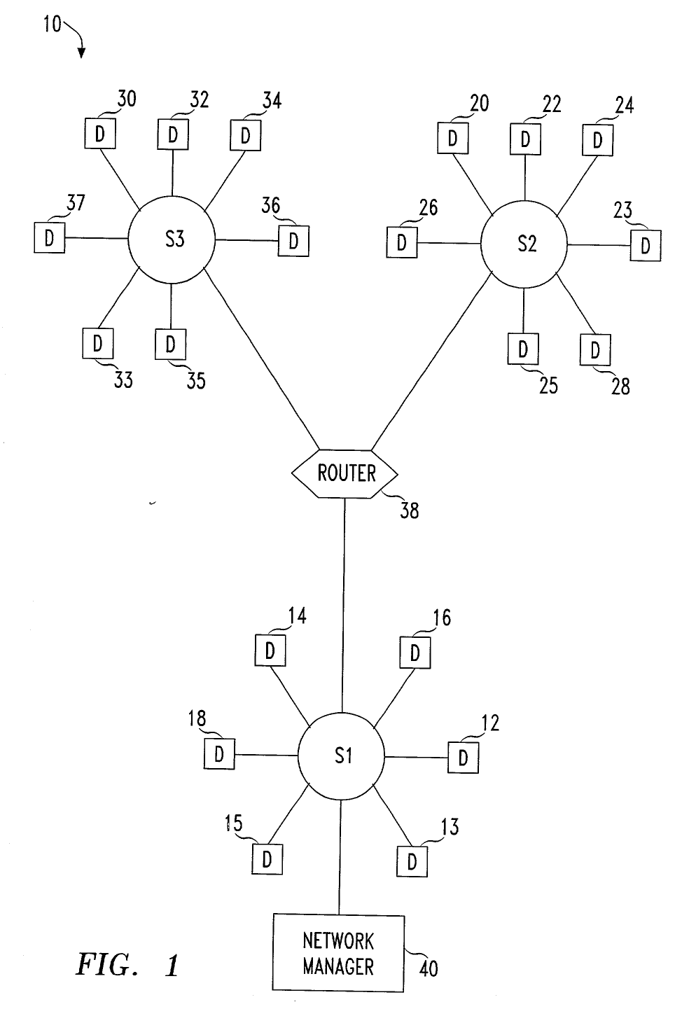

FIG. 1 shows a network 10 which, for illustrative purposes, includes a first, second and third subnetworks (hereinafter referred to as subnets) S1, S2 and S3. The subnets S1, S2 and S3 can have the same topologies or they can have different topologies. The topologies include, but are not limited to, Token ring, Ethernet, X.25 and FDDI. Devices 12, 13, 14, 15, 16 and 18 are connected to the first subnet S1; devices 20, 22, 23, 24, 25, 26 and 28 are connected to the second subnet S2; and devices 30, 32, 33, 34, 35, 36, and 37 are connected to the third subnet S3. A router 38 interconnects the first, second and third subnets S1, S2 and S3.

The devices or hosts 12-37 can be workstations, personal computers, hubs, printers, network adapters, multiplexers, etc. It should be noted that for the purposes of this document, the terms “hosts” and “devices” are used interchangeably. The network 10 is scalable, which allows computing resources to be added as needed. Although only a small number of devices 12-38 are shown, the network 10 can encompass many addressable devices, for instance, up to tens of thousands of addressable devices.

Each device 12-38 has a physical address and a unique Internet protocol (IP) address. For example, TCP/IP may be used as the protocols that regulate how data are packeted into IP packets and transported between the devices 12-38. Network 10 may also include a network manager 40 that is connected to the first subnet S1, and any suitable management protocol may be used in the operation of the network.

Router 38 is provided with one or more filters to help secure data around the network. Each filter is a set of rules that determine how the router will transmit data. As mentioned above, a filter will be written after a network is implemented in order to address specific circumstances of the network operation. Often, these specific filters are written by individuals who are not experts at writing filters. As a result, although the intended purposes of the filters may be highly desirable, the filters themselves may not be effective or may have adverse unintended consequences.

Generally, in accordance with the present invention, a set of pre-written filter are provided, and a program is run on a computer to identify one of these pre-written filters as a substitute for the filter that was written specifically for the router. That identified substitute filter is loaded onto the router, and used instead of the filter that had been specifically written for the router. Preferably, the computer program is used to identify which one of the pre-written filters of the pre-written filter files most closely matches, according to a predefined test, the filter written specifically for the router.

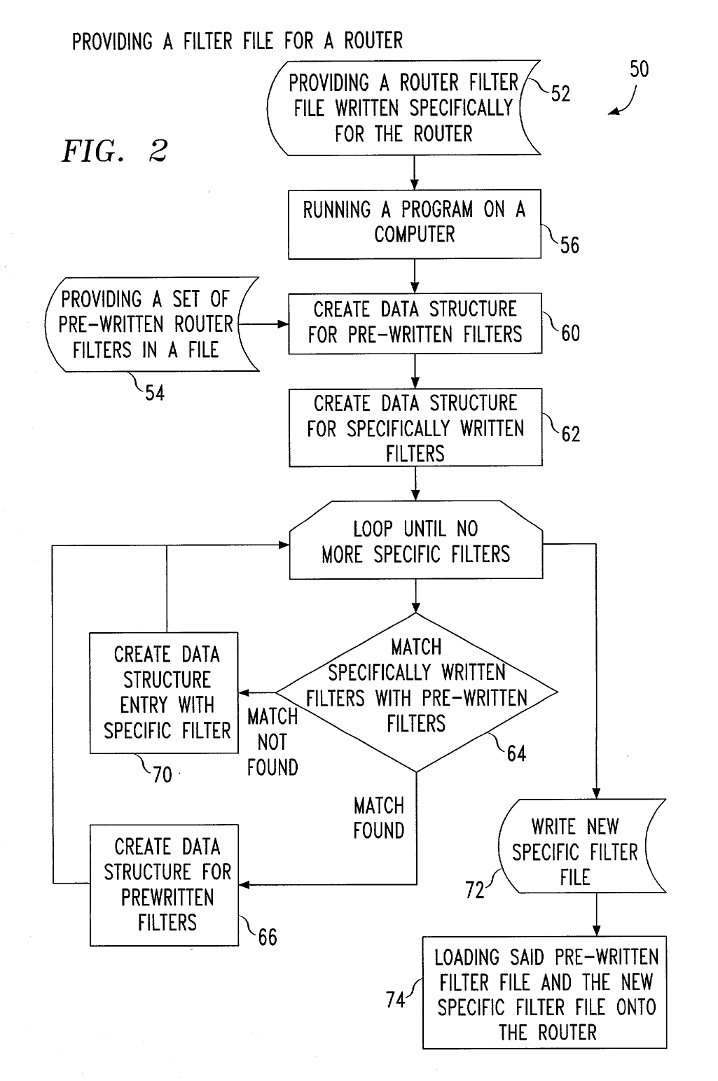

FIG. 2 illustrates a preferred routine 50 for identifying one or more substitute filters for specifically written filter or filters. In this routine, step 52 represents providing a router filter file written specifically for the router, and step 54 represents providing a set of prewritten router filters in a file. Step 56 represents running the computer program.

At steps 60 and 62, data structures are created for the pre-written filter and for the specifically written filters. As represented by step 64, the specifically written filters are matched with the pre-written filters. When a match for a specifically written filter is found, the routine, as represented by step 66, creates a data structures for the matched pre-written filter; and when no match is found for a specifically written filter, the routine, as represented by step 70, creates a data structure entry with the specific filter. Steps 64, 66 and 70 are repeated until searches have been performed to find matches ro all the specifically written filters. Then, at step 72, a new specific filter file is written, and at step 74, the pre-written filter file and the new specific filter file are loaded onto the router.

Any suitable set of pre-written filters may be used in the practice of this invention. For example, standard commercially available filters may be used, or non-standard filters may be used.

Likewise, any suitable criteria and procedures may be employed to identify the appropriate substitute filter for the specifically written filter. These criteria and procedures may be identified in advance, or may be determined at the time the program is run to identify the substitute filter. Also, the criteria and procedures may be provided by the individuals or entities who provide the pre-written filters, or by the individuals or entity who wrote the specifically written filter.

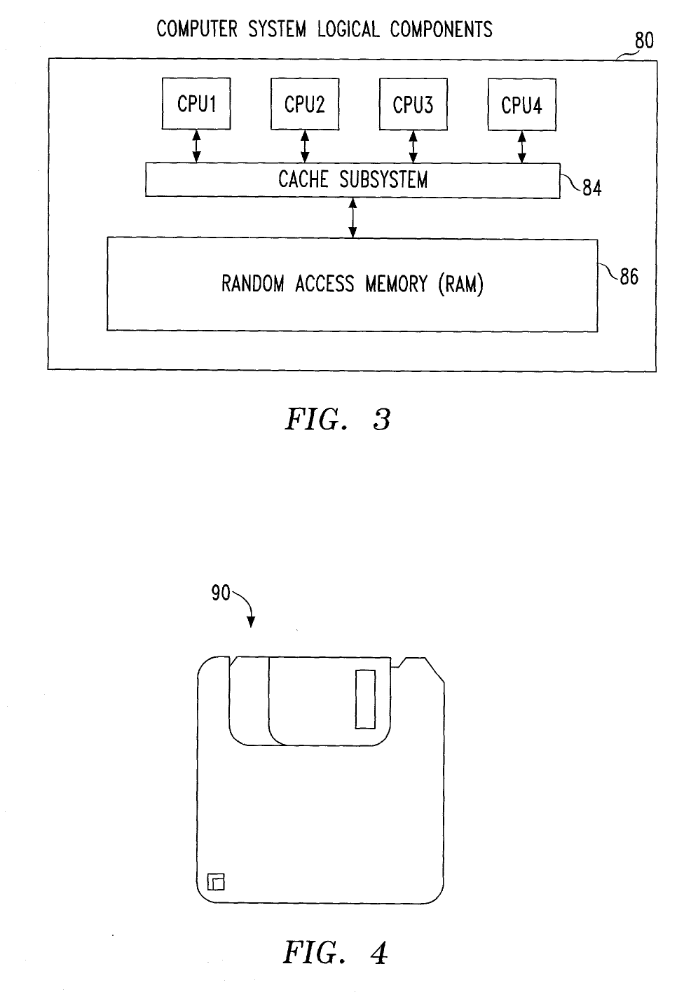

As will be understood by those skilled in the art, any suitable computing or calculating system or apparatus may be used to practice this invention. For example, a suitable computer system illustrated at 80 in FIG. 3 may be used. System 80, generally, comprises a series of CPUs, a cache subsystem 84, and a random access memory (RAM) 86. Also, as will be understood by those skilled in the art, the present invention may be embodied in a computer program storage device (including software embodied in a magnetic, electrical, optical or other storage device). One suitable storage medium is illustrated, for example, at 90 in FIG. 4.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method of providing a filter for a router, comprising the steps of:
providing a set of pre-written router filters within one or more files;
providing a router filter written specifically for the router;
running a program on a computer to identify one of the pre-written filter files as a substitute for said specifically written filter; and
loading said one of the pre-written filters onto the router.

2. A method according to claim 1, wherein the running step includes the step of running the program on the computer to identify which one of the pre-written filters most closely matches, according to a defined test, said specifically written filter.

3. A method according to claim 2, wherein said test is a pre-defined test.

4. A method according to claim 1, wherein the running step includes the step of running the program on the computer to identify which one of the pre-written filters most closely matches the specifically written filter according to a predefined set of criteria.

5. A method according to claim 1, wherein the step of running the program includes the step of identifying defined features of the specifically written filter, and searching the pre-written filters for the identified defined features.

6. A system for providing a filter for a router, comprising:
computer readable medium including a set of pre-written router filters;
computer readable medium including a router filter written specifically for the router;
computer readable medium including a program for running on a computer to identify one of the pre-written filters as a substitute for said specifically written filter; and
means for loading said one of the pre-written filters onto the router.

7. A system according to claim 6, wherein the program includes means to identify which one of the pre-written filters most closely matches, according to a defined test, a filter in the said specifically written filter file.

8. A system according to claim 7, wherein said test is a pre-defined test.

9. A system according to claim 6, wherein the program includes means to identify which one of the pre-written filter files most closely matches the specifically written filter file according to a predefines set of criteria.

10. A system according to claim 1, wherein the program includes means for identifying defined features of the specifically written filters, and for searching the pre-written filters for the identified defined features.

11. A program storage device readable by machine, tangibly embodying a program of instructions executable by the machine to perform method steps for identifying a filter for a router, said method steps comprising:
reading a set of pre-written router filters within one or more filter files;
reading a router filter file written specifically for the router; and
identifying one of the pre-written filters within the pre-written filter files as a substitute for said specifically written filter within the router specific filter file.

12. A program storage device according to claim 11, wherein the identifying step includes the step of identifying which one of the pre-written filter files most closely matches, according to a defined test, said specifically written filter file.

13. A program storage device according to claim 11, wherein said method steps further include the step of loading the identified filter file onto the router.

14. A program storage device according to claim 11, wherein the identifying step includes the step of identifying which one of the pre-written filters most closely matches the specifically written filter file according to a predefines set of criteria.

15. A program storage device according to claim 11, wherein the identifying step includes the step of identifying defined features of the specifically written filter file, and searching the pre-written filter files for the identified defined features.
